(19) United States
(12) Patent Application Publication
(10) Pub. No.: US 2006/0265936 A1
(43) Pub. Date: Nov. 30, 2006

(54) Simulated crab lure

(76) Inventor: F. Charles Wilkinson, Hockessin, DE (US)

Correspondence Address: CONNOLLY BOVE LODGE & HUTZ, LLP, P O BOX 2207, WILMINGTON, DE, 19899, US

(21) Appl. No.: 11/137,751

(22) Filed: May 25, 2005

(51) Int. Cl. A01K 85/00

(52) U.S. Cl. 43/42.47

(57) ABSTRACT

A lure for attracting and engaging a fish includes a main body shaped so as to resemble a crab. A bill extends from a forward end of the body. A keel extends from a bottom of the body and terminates at one side at the bill to maintain stability of the lure when in motion. Swim fins and/or legs extend from a lateral edge of the body for increased stability and for more realistically simulating an actual crab. A hook extends from a rear of the body for engaging a fish attracted to the lure. A wire harness extends between the forward end and the rearward end of the body to strengthen the body.

### BACKGROUND OF THE INVENTION

1. Field of the Invention

This invention relates to fishing lures, and more particularly pertains to a simulated crab lure for attracting and engaging a fish.

2. Description of the Related Art

The use of fishing lures is known in the prior art. Two prior patents concern lures with a crab-like shape. U.S. Pat. No. 4,928,422 shows a crab-like artificial lure that is legless and weighted toward one end. Two metal eyes are screwed into the crab-body shaped lure at spaced apart locations. A hook is attached to one of the eyes and a reel line is attached to the other eye. The crab-like lure preferably is formed of wood or alternatively is of molded plastic. In one embodiment, a plastic bill or bow plane is attached to the same end of the crab-like lure where the reel line is attached.

U.S. Pat. No. 5,546,694 describes a simulated crab lure with a crab-shaped main body that has a bill extending from a forward end and a hook extending from a rear end. A keel extends from the bottom of the body to help maintain stability of the lure in the water. The keel is spaced apart from the bill and no structure resembling crab legs extends from the crab body.

While crab-like shaped lures have achieved success for fishing in waters known to contain crab, improvements in stability and maneuverability are still sought. In these respects, the simulated crab lure according to the present invention substantially departs from the conventional concepts and designs of the prior art, and in so doing provides an apparatus primarily developed for the purpose of attracting and engaging a fish.

### SUMMARY OF THE INVENTION

[Pat will complete summary of invention once claims are satisfactory.]

Other objects of the invention will be clear from the following description.

### BRIEF DESCRIPTION OF THE DRAWINGS

The invention will be better understood when consideration is given to the following detailed description. Such description makes reference to the annexed drawings wherein:

FIG. 1 is a left side elevational view of a simulated crab lure of the present invention;

FIG. 2 is a front elevational view thereof;

FIG. 3 is a rear elevational view thereof;

FIG. 4 is a top plan view thereof;

FIG. 5 is a right side elevational view thereof;

FIG. 6 is a cross-sectional plan view taken along line 6-6 of FIG. 1;

FIG. 7 is a cross-sectional view in elevation taken along line 7-7 of FIG. 2, showing optional weights; and

FIG. 8 is a cross-sectional view in elevation similar to FIG. 7, but showing optional fluid reservoir and optional rattle chamber.

### DESCRIPTION OF THE PREFERRED EMBODIMENTS

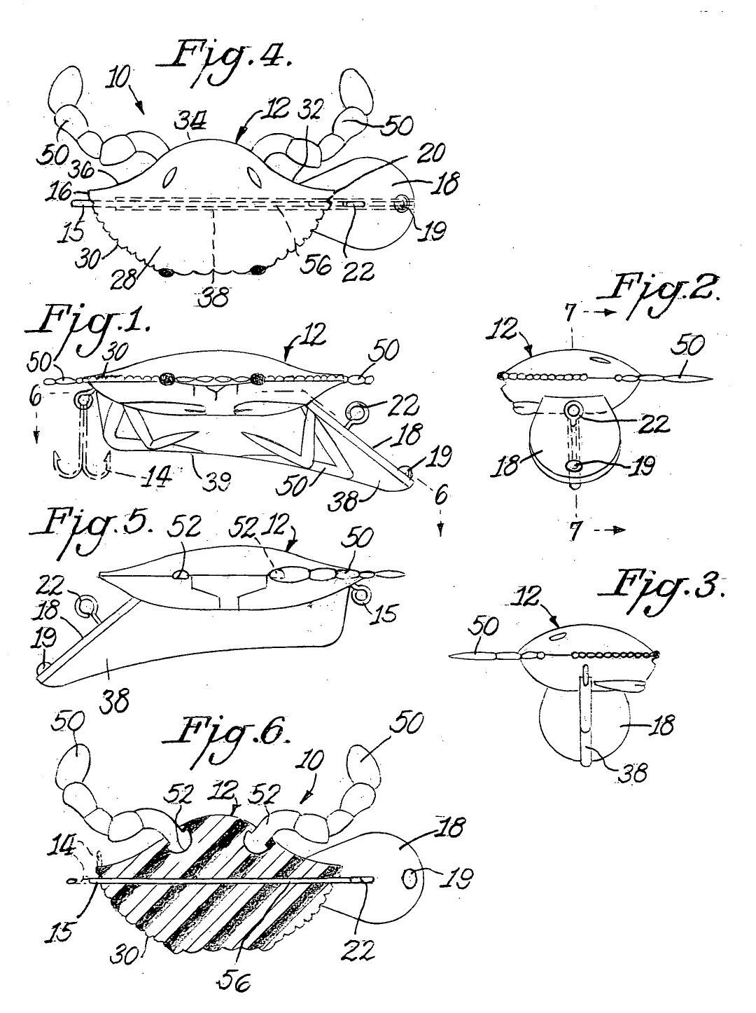

With reference now to the drawings, and in particular to FIGS. 1-8, a new simulated crab lure embodying the principles and concepts of the present invention and generally designated by the reference numeral 10 will be described.

The simulated crab lure 10 comprises a crab body 12 shaped so as to substantially simulate or imitate an appearance of a crab. A hook (or series of hooks) 14 extends from an eyelet 15 at a rearward end 16 of the crab body 12 for engaging a fish attracted to the lure 10. A bill or spoon 18 projects from a forward end 20 of the crab body 12 for hydrodynamically biasing the crab body in response to movement of the lure 10 through a fluid, such as water. When the line 24 attached to the line anchor 22 on the bill 18 is cranked, or the fishing rod associated with the line 24 is twitched, the lure 10 will dive. If the retrieve is stopped, depending upon the weights within the lure 10, the lure 10 will surface, suspend or sink.

Preferably, the bill 18 is formed from a clear plastic or other transparent material so that when the lure 10 enters the water, such bill or spoon 18 will almost disappear from sight. Suitable plastic transparent materials include polypropylene and ABS plastic, and other transparent materials that will withstand exposure to customary water and temperature conditions encountered when fishing may be used. A line anchor 22, such as an eyelet, is secured to the bill 18 proximal to a center thereof and permits attachment of a fishing line 24 to the lure 10. Optionally, the bill 18 may include one or more attached weights 19 to compensate for a weight of the hook(s) 14 and to assist in orienting the lure 10 to an upright position when in a fluid, such as water.

The crab body 12 is desirably formed of a substantially buoyant material and optionally may include one or more weights 26 positioned therein (FIG. 7) which compensates for the weight of the hook(s) 14 so as to substantially balance the crab body 12 about a transverse axis directed between the forward end 20 and the rearward end 16 of the lure 10. Weights 26 also assist in orienting the lure 10 to an upright position when in a fluid such as water. Weights 26 may be added or removed to cause the lure 10 to float, suspend, or sink to a desired depth within the water to adjust to differing fishing conditions.

As best illustrated in FIGS. 1 and 4, the crab body 12 according to the present invention 10 is shaped so as to define a domed upper surface 28 having an outer peripheral edge extending between the rearward end 16 and the forward end 20. The outer peripheral edge of the domed upper surface 28 is shaped so as to define an arcuate lateral edge 30 extending between the forward end 20 and the rearward end 16 along a first side of the crab body 12. The arcuate lateral edge 30 has an approximately constant radius of curvature and is therefore somewhat semi-circular in shape. The lateral edge 30 preferably has scalloped or pointed projections extending therefrom to more accurately simulate the shape of an upper crab shell.

In contrast to the lateral edge 30, a periphery of the domed upper surface 28 along a second side of the crab body 12 is shaped to define an involute forward edge 32 integrally continuing into an arcuate lateral edge 34 which intersects an involute rear edge 36 terminating at the rearward end 16 of the crab body 12. Such configuration of the outer periphery of the domed upper surface 28 causes the crab body 12 to assume the appearance of a crab so as to attract fish naturally attracted to such prey.

A through-wire harness 56 (FIG. 6) extends between the eyelet 15 at the rearward end 16 of the lure 10 and the line anchor 22 extending from the bill 18. The through-wire harness 56 strengthens the lure 10 so that the lure 10 is better able to withstand hits from large fish. The through-wire harness 56 takes the stress of the tension forces applied between the hook 14 and line anchor 22 when a fish lands the hook 14. Preferably, the through-wire harness 56 is a metal, such as stainless steel, but any material suitable to increase the tensile strength of the crab lure 10 may also be used. Preferably, as best shown in FIGS. 6 and 7, the line anchors 15 and 22 are formed or molded at each end of a single wire of stainless steel, which wire also then forms the through-wire harness 56.

As shown in FIG. 1, the crab body 12 further comprises a depending keel 38 extending from the bottom surface 37 of the crab body 12 and below the domed upper surface 28. The depending keel 38 extends downwardly (e.g., oppositely) from the domed upper surface 28. Preferably, the keel 38 extends from the bottom surface 37 of the crab body 12 substantially between the forward end 20 and the rearward end 16. In this embodiment, the keel 38 terminates at one side at the bill 18. As shown in FIG. 1, the side of the keel 38 is connected or attached to or is contiguous with the bottom side of the bill 18.

As an improvement over the crab lure of U.S. Pat. No. 5,546,694, the keel 38 extends along substantially the entire length of the crab body 12 from forward end 20 to rearward end 16, and the side connected or contiguous with the bill 18 has a side length substantially equal to the length of the bill 18 (see FIG. 1) such that the keel 38 extends to the tip of the bill 18. In this preferred embodiment, the side length of the front side of the keel 38 connected to the bill 18 is longer than the side length of the rear side of the keel 38. The bottom edge of such preferred keel 38 adopts a slight convexly shaped curve. Such keel 38 configuration helps to stabilize the lure 10 in the water so that the crab body 12 remains upright, and also helps cause the lure 10 to track straight on retrieve.

The keel 38 preferably is formed of a clear plastic or other transparent material so that when the lure enters the water, such keel 38 will almost disappear from sight. However, such keel 38 optionally may be embellished with representations of one or more crab legs 39 (see FIG. 1) or other fish attracting designs, such as by painting thereon or applying a decal thereto or laminating a layer thereto. Such embellishments 39 preferably are applied to both the front and rear side of the keel 38 in mirror image to give the appearance of legs suspended under the crab body 12.

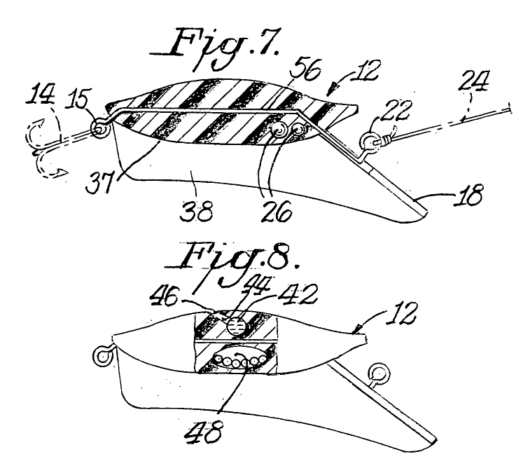

Preferably, the crab body 12 is comprised of molded plastic, such as ABS plastic or polypropylene, but may also be comprised of any conventionally known material, such as balsa or cedar wood, rubber, elastomers, or the like, that may withstand the water and temperature conditions customary when fishing. The crab body 12 is preferably constructed of a substantially buoyant material which tends to rise in fluids such as water so as to attain the orientation illustrated in FIGS. 1 and 5. The crab body 12 may be embellished with representations of eyes or crab shell striations to better simulate an actual crab. In one embodiment, eyes and crab claws are painted onto the surface of the crab body 12 (see FIG. 1).

As a further improvement over the crab lure of U.S. Pat. No. 5,546,694, swim fins 50 may extend from the involute forward edge 32 and the involute rear edge 36 to more realistically simulate an actual crab. The swim fins 50 can help to stabilize the lure 10 in an upright orientation when tracking. Such swim fins 50 further act as outriggers, like outriggers found on canoes. Such swim fins 50 may be integrally molded with the crab body 12 or may be separately attached thereto, such as by inserting one end into a receptive port opening, bore or cavity 52 and held therein with an adhesive, or may be removably attached thereto, such as by inserting one end into a receptive port opening 52 by force fit. FIG. 5 shows a lure 10 wherein a swim fin 50 is inserted into one port opening 52, whereas the other port opening 52 remains open.

In one embodiment, the end of the swim fin fitted into the receptive port opening 52 is keyed or shaped in a manner to deter rotation of the swim fin 50 with respect to the crab body 12. Preferably, the swim fins 50 have a flat proximal end that fits within the receptive port opening 52 so that the swim fins 50 do not spin with respect to the crab body 12 when in water or otherwise under pressure.

To make the lure 10 more attractive to fish, preferably such swim fins 50 are formed of rubber, flexible plastic or other flexible material so that the tips of the swim fins 50 may move independently with reference to the crab body 12. In addition, the swim fins 50 optionally may be impregnated with a scent that is attractive to fish. Other legs (not shown) made from the same materials may also be attached to or glued to the crab body 12 as desired.

Referring to FIG. 7, one or more optional weights 26 may be incorporated into the crab body 12 to balance out the weight of the hook 14. Alternatively, as shown in FIG. 1, an optional weight 19 may be included in or on the bill 18 for this same purpose. A single lure 10 might include a combination of weights 26 and weight 19.

As shown in FIG. 8, the simulated crab lure 10 of the present invention may further comprise a dispensing means for selectively dispensing a scented fluid from the crab body 12. To this end, the crab body 12 can be shaped so as to define a fluid reservoir 42 positioned therewithin which fluidly communicates through a fluid conduit 44 with a dispensing aperture 46. By this structure, a scented fluid commonly known in the art can be positioned within the fluid reservoir 42 through the dispensing aperture 46 and the fluid conduit 44, whereby an immersion of the lure 10 and a movement thereof through a body of water will result in dispensing of the scented fluid from the fluid reservoir 42 out the dispensing aperture 46 as a result of fluid passing over the crab body 12.

With reference to FIG. 8, the crab body 12 of the lure 10 may be additionally shaped so as to define a rattle chamber 48 formed therewithin. A plurality of rattle members such as steel balls or the like (not labeled in FIG. 8) can be positioned within the rattle chamber 48 so as to create a sound during movement of the device 10, which simulates a sound of impacting claws against a shell of a natural crab. By this structure, a more realistic simulation of an actual crab is obtained.

In use, the simulated crab lure 10 according to the present invention can be easily utilized for attracting and capturing fish which normally feed on crabs. The present invention, when constructed with the dispensing means 42, 44, 46 within the crab body 12 can be further utilized to dispense a scented fluid so as to increase effectiveness of the device 10 in capturing fish attracted to such scented fluid.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Other embodiments of the invention will be apparent to those skilled in the art from a reading of the specification and practice of the invention disclosed herein. Therefore, the specification and examples are to be considered as exemplary, and the scope and spirit of the invention shall be indicated by the following claims.

1. A simulated crab lure, comprising:
a crab body shaped so as to substantially simulate an appearance of a crab, said crab body being formed of a substantially buoyant material;
a bill projecting from a forward end of the crab body, said bill having a top surface and a bottom surface;
a line anchor integral with or secured to the bill and spaced from the crab body to permit attachment of a fishing line to the lure;
a means for attaching a hook or series of hooks extending from the crab body;
a harness extending between the line anchor and the means for attaching a hook; and
a depending keel extending from a bottom surface of the crab body substantially between the forward end and the rearward end of the crab body, wherein an edge of the keel contacts a major portion of the length of the bottom surface of the bill.

2. The simulated crab lure of claim 1, wherein the harness is a through-wire harness formed of a metal.

3. The simulated crab lure of claim 2, wherein the through-wire harness is formed of a metal wire having a line anchor formed at one end and an eyelet for receiving a hook or series of hooks formed at the opposite end.

4. (canceled)

5. The simulated crab lure of claim 1, wherein a side edge of the keel contacts the bill.

6. The simulated crab lure of claim 1, wherein a side edge of the keel is integral with the bill.

7. The simulated crab lure of claim 1, wherein the keel is formed of a transparent material.

8. The simulated crab lure of claim 7, wherein the keel includes an embellishment.

9. The simulated crab lure of claim 1, further comprising a weight attached to the bill.

10. The simulated crab lure of claim 1, further comprising swim fins.

11. The simulated crab lure of claim 10, wherein each swim fin is attached to the crab body.

12. The simulated crab lure of claim 10, wherein the swim fin is formed of a flexible material selected from the group consisting of rubber, thermoformable plastic and polypropylene.

13. A simulated crab lure, comprising:
a crab body shaped so as to substantially simulate an appearance of a crab, said crab body being formed of a substantially buoyant material;
a bill projecting from a forward end of the crab body, said bill having a top surface and a bottom surface;
a line anchor integral with or secured to the bill and spaced from the crab body to permit attachment of a fishing line to the lure;
a means for attaching a hook or series of hooks extending from the crab body; and
a depending keel extending from a bottom surface of the crab body substantially between the forward end and the rearward end of the crab body, wherein at least a portion of an edge of the keel is contiguous with at least a portion of the bottom surface of the bill.

14. The simulated crab lure of claim 13, wherein a side edge of the keel contacts the bill.

15. The simulated crab lure of claim 13, wherein a side edge of the keel is integral with the bill.

16. The simulated crab lure of claim 13, wherein the keel is formed of a transparent material.

17. The simulated crab lure of claim 16, wherein the keel includes an embellishment.

18. The simulated crab lure of claim 13, further comprising a weight attached to the bill.

19. The simulated crab lure of claim 13, further comprising swim fins.

20. The simulated crab lure of claim 19, wherein each swim fin is attached to the crab body.

21. The simulated crab lure of claim 19, wherein each swim fin is formed of a flexible material selected from the group consisting of rubber, thermoformable plastic, and polypropylene.
